(19) United States
(12) Patent Application Publication
(10) Pub. No.: US 2005/0089659 A1
(43) Pub. Date: Apr. 28, 2005

(54) Water-soluble containers

(75) Inventors: Daniele Fregonese, Ludwigshafen (DE); Dora Zamuner, Mira (IT)

Correspondence Address: NORRIS, MCLAUGHLIN & MARCUS, 875 THIRD AVE, 18TH FLOOR, NEW YORK, NY, 10022, US

(73) Assignee: Reckitt Benckiser N.V., Hoofddorp (NL)

(21) Appl. No.: 10/511,332

(22) PCT Filed: Mar. 17, 2003
(86) PCT No.: PCT/GB03/01153

(30) Foreign Application Priority Data
Apr. 20, 2002 (GB) 0209093.4

(51) Int. Cl. F16L 1/00

(52) U.S. Cl. 428/35.7

(57) ABSTRACT

The present invention relates to a water-soluble container comprising at least one compartment prepared from a thermoformed sheet of hydroxy propyl methyl cellulose (HPMC) and to a process for preparing such a container.

The present invention relates to a water-soluble container comprising at least one compartment prepared from a thermoformed sheet of hydroxy propyl methyl cellulose (HPMC) and to a process for preparing such a container.

It is known to package chemical compositions, particularly those which may be of a hazardous or irritant nature, in films, particularly water soluble films. Such containers can simply be added to water in order to dissolve or disperse the contents of the container into the water.

WO 89/12587 discloses a package which comprises an envelope of a water soluble material which comprises a flexible wall and a water-soluble heat seal. The package may contain an organic liquid comprising, for example, a pesticide, fungicide, insecticide or herbicide.

EP 1 126 070 relates to laundry additive sachets which may be made from HPMC film. No detailed discussion is given on how the sachets may be prepared. The single Example provides no details. Paragraph 0013 simply states that they can be prepared by known methods in the art, specifically by first cutting an appropriately sized piece of film, folding the film to form the necessary number and size of compartments and sealing the edges, for example by heat sealing. There is no reference to thermoforming of HPMC.

EP0284191 describes water-soluble films which are laminates of HPMC with poly(vinylalcohol)[PVOH]. The films are simply sealed together to form a pouch without any thermoforming step.

WO0161099 describes a water-soluble sachet for use as a laundry wash additive. The sachet is preferably made from HPMC. However, no processes for making the sachet are described.

WO0160966 describes a water-soluble sealed pouch containing a detergent product, HPMC is mentioned as a possible polymer film amongst many other polymers listed. A number of techniques are mentioned for producing the pouch including thermoforming. All of the examples are made using PVOH film.

JP5139420 describes a process by which the surface of a solid composition is made molten and a water-soluble film, HPMC is listed as one of a number of examples, is pressed onto the surface of the solid composition. It is preferred that the film is also heated prior to compression.

JP 19940151643 describes a new HPMC film containing polyvinyl-pyrrolidone and polyethylene gycol which is made by a cast extrusion process. It is stated that the new film is heat sealable.

JP6273412 describes a cup for collecting faeces or blood samples which is water-soluble. It is made up of water dispersible fibres which are coated with a water-soluble resin, one of the many examples quoted being HPMC.

A well known problem with a sachet made from PVOH is that the PVOH is easily cross-linked and, subsequently, made less water soluble by certain cross-linking agents. A known cross-linking agent are perborate bleaching compounds commonly found in fabric detergents. Cross-linking may be avoided by eliminating unsuitable compounds from the sachet. However, when a sachet is used on top of a main detergent in the wash, such as a wash additive, then cross-linking agents commonly found in any number of fabric detergents on the market may cause cross-linking of the PVOH material. There is a need to use films that do not cross link, especially for wash additive products.

A suitable film for making sachets is HPMC. However, HPMC is known to have poor physical properties, such as a very low tear strength, which previously has meant that this film is thought to be unsuitable for use in standard thermoforming processes, where stretching is an inevitable outcome of the process.

Surprisingly, we have succeeded in thermoforming HPMC by careful selection of the conditions, both with carrier technology [such as by the use of a PET film, ideally 200-250 micron thick, which is passed through the thermoforming machine underneath the HPMC film (see GB2362868 for a more detailed explanation of the technique], and without the use of carrier technology. The reason for using the carrier technology is to help the film to maintain its shape and to reduce the physical stresses on the HPMC film during thermoforming.

HPMC of different thicknesses can be used (ideally from 75 to 120 micron) without any tearing. On-line lamination of HPMC, where two or more films pass through the thermoformer and are laminated during the forming step (for example, with two films of HPMC 75 micron each thermoformed together), is also possible.

Another important finding is that HPMC can be sealed easily and produces a seal with good resistance to breaking.

The present invention provides a water-soluble container comprising at least one compartment prepared from a thermoformed film of hydroxy propyl methyl cellulose (HPMC).

A further feature of the invention is a process for preparing a water-soluble container comprising at least one compartment which comprises:
a. feeding at least one HPMC film into a thermoforming machine;
b. heating the at least one HPMC film to a temperature of 120 to 140° C., ideally 125 to 135° C., preferably for 1 to 10 seconds, ideally 2 to 6 seconds;
c. simultaneously or subsequently forming the at least one heated HPMC film into a mould, which is preferably cooled (below room temperature, ideally below 20° C.);
d. filling the formed film pocket with at least one liquid or solid composition; and
e. sealing the formed and filled film pocket with a water-soluble film, preferably an HPMC film.

In the process of the present invention two or more compartments can be made. Each container may be a single compartment or comprise two or more individual compartments.

For example each container may be separated by one or more dividing walls into two or more individual compartments.

The film may be a single film, or a laminated film as disclosed in GB-A-2,244,258. Preferably at least one film of the water-soluble laminate film is HPMC.

The film may be produced by any suitable process, for example by extrusion and blowing or by casting. At present generally only cast film is commercially available, such as from agents like Aquafilm (UK), Hartlebury, Worcestershire, DY10 4JB and produced by ENAK Redkiln Way Horsham Sussex England RH13 5QH. Other manufacturer include Cast of USA.

The thickness of the film used to produce the pouches is preferably 40 to 300 μm, more preferably 70 to 200 μm, especially 80 to 160 μm, more especially 90 to 150 μm and most especially 75 to 120 μm.

In a thermoforming process a film may be drawn down or blown down into a mould after it has been heated. Thus, for example, the film is heated to the thermoforming temperature using a thermoforming heater plate assembly, and then drawn down under vacuum or blown down under pressure into the mould. Plug-assisted thermoforming and pre-stretching the film, for example by blowing the film away from the mould before thermoforming, may, if desired, be used. The exact amount of vacuum or pressure and the exact thermoforming temperature used depend on the thickness and porosity of the film used.

A suitable forming pressure is, for example, 69 to 138 kPa, especially 83 to 117 kPa. A suitable forming vacuum is 0 to 4 kPa, especially 0 to 2 kPa. A suitable time for the film to be held in the mould (“dwell time”) is, for example, 0.4 to 2.5 seconds, especially 2 to 2.5 seconds.

After the compartments have been formed, they are filled with the desired composition(s) which are intended to be released in an aqueous environment.

The compositions may be a fabric care, surface care or dishwashing composition. Thus, for example, they may be a dishwashing, water-softening, laundry or detergent composition, or a rinse aid. Such compositions may be suitable for use in a domestic washing machine. The compositions may also independently be a disinfectant, antibacterial or antiseptic composition, or a refill composition for a trigger-type spray. Such compositions are generally packaged in total amounts of from 5 to 100 g, especially from 15 to 40 g. For example, a dishwashing composition may weigh from 15 to 30 g, a water-softening composition may weigh from 15 to 40 g.

The compartment(s) may be completely filled or only partially filled. Each composition independently may be a solid. For example, it may be a particulate or granulated solid, or a tablet. Each composition may also independently be a liquid, which may be thickened or gelled if desired. The liquid composition may be non-aqueous or aqueous, for example comprising less than or more than 5% or less than or more than 10 wt % total or free water. Desirably the compositions contain less than 80 wt % water.

Each composition may have more than one phase. For example each composition may comprise an aqueous composition and a liquid composition which is immiscible with the aqueous composition. Each composition may also comprise a liquid composition and a separate solid composition, for example in the form of a ball, pill or speckles.

The compositions may be appropriately chosen depending on the desired use of the article. For example in a pouch comprising two or more compartments may contain the following:
1. laundry washing, the primary composition may comprise, for example, a detergent, and the secondary composition may comprise a bleach, stain remover, water-softener, enzyme or fabric conditioner. The article may be adapted to release the compositions at different times during the laundry wash. For example, a bleach or fabric conditioner is generally released at the end of a wash, and a water-softener is generally released at the start of a wash. An enzyme may be released at the start or the end of a wash.
2. fabric conditioner, the primary composition may comprise a fabric conditioner and the secondary component may comprise an enzyme which is released before or after the fabric conditioner in a rinse cycle.
3. dish washing the primary composition may comprise a detergent and the secondary composition may comprise a water-softener, salt, enzyme, rinse aid, bleach or bleach activator. The article may be adapted to release the compositions at different times during the laundry wash. For example, a rinse aid, bleach or bleach activator is generally released at the end of a wash, and a water-softener, salt or enzyme is generally released at the start of a wash.
4. laundry additive. The primary composition may contain a bleaching system, preferably as a powder (e.g. sodium percarbonate, perborate or K or NaDIC potassium or sodium di-chloroisocyanurate, or KHSO₃ potassium persulfate or an activator, such as, phthalyimido peroxyhexanoic acid (PAP as supplied by Ausimont) or a nitrile quat., such as methylmorpholin aceto nitrile di-sulfate (example SOKALAN BM G suplied by BASF). The secondary composition may contain a solid, liquid or gel based on enzyme and surfactants.

The ingredients of each composition depend on the use of the composition. Thus, for example, the composition may contain surface active agents such as an anionic, nonionic, cationic, amphoteric or zwitterionic surface active agents or mixtures thereof.

Examples of anionic surfactants are straight-chained or branched alkyl sulfates and alkyl polyalkoxylated sulfates, also known as alkyl ether sulfates. Such surfactants may be produced by the sulfation of higher C₈-C₂₀ fatty alcohols.

Examples of primary alkyl sulfate surfactants are those of formula:
ROSO₃⁻M⁺
wherein R is a linear C₈-C₂₀ hydrocarbyl group and M is a water-solubilising cation. Preferably R is C₁₀-C₁₋₆ alkyl, for example C₁₂-C₁₄, and M is alkali metal such as lithium, sodium or potassium.

Examples of secondary alkyl sulfate surfactants are those which have the sulfate moiety on a “backbone” of the molecule, for example those of formula:
CH₃ (CH₂)ₙ(CHOSO₃⁻M⁺)(CH₂)ₘCH₃
wherein m and n are independently 2 or more, the sum of m+n typically being 6 to 20, for example 9 to 15, and M is a water-solubilising cation such as lithium, sodium or potassium.

Especially preferred secondary alkyl sulfates are the (2,3) alkyl sulfate surfactants of formulae:
CH₃(CH₂)ₓ(CHOSO₃⁻M⁺)CH₃ and
CH₃(CH₂)ₓ(CHOSO₃⁻M⁺)CH₂CH₃
for the 2-sulfate and 3-sulfate, respectively. In these formulae x is at least 4, for example 6 to 20, preferably 10 to 16. M is cation, such as an alkali metal, for example lithium, sodium or potassium.

Examples of alkoxylated alkyl sulfates are ethoxylated alkyl sulfates of the formula:
RO(C₂H₄O)ₙSO₃⁻M⁺
wherein R is a C₈-C₂₀ alkyl group, preferably C₁₀-C₁₈ such as a C₁₂-C₁₆, n is at least 1, for example from 1 to 20, preferably 1 to 15, especially 1 to 6, and M is a salt-forming cation such as lithium, sodium, potassium, ammonium, alkylammonium or alkanolammonium. These compounds can provide especially desirable fabric cleaning performance benefits when used in combination with alkyl sulfates.

The alkyl sulfates and alkyl ether sulfates will generally be used in the form of mixtures comprising varying alkyl chain lengths and, if present, varying degrees of alkoxylation.

Other anionic surfactants which may be employed are salts of fatty acids, for example C₈-C₁₈ fatty acids, especially the sodium or potassium salts, and alkyl, for example C₈-C₁₈, benzene sulfonates.

Examples of nonionic surfactants are fatty acid alkoxylates, such as fatty acid ethoxylates, especially those of formula:
R(C₂H₄O)ₙOH
wherein R is a straight or branched C₈-C₁₆ alkyl group, preferably a C₉-C₁₅, for example C₁₀-C₁₄, alkyl group and n is at least 1, for example from 1 to 16, preferably 2 to 12, more preferably 3 to 10.

The alkoxylated fatty alcohol nonionic surfactant will frequently have a hydrophilic-lipophilic balance (HLB) which ranges from 3 to 17, more preferably from 6 to 15, most preferably from 10 to 15.

Examples of fatty alcohol ethoxylates are those made from alcohols of 12 to 15 carbon atoms and which contain about 7 moles of ethylene oxide. Such materials are commercially marketed under the trademarks Neodol 25-7 and Neodol 23-6.5 by Shell Chemical Company. Other useful Neodols include Neodol 1-5, an ethoxylated fatty alcohol averaging 11 carbon atoms in its alkyl chain with about 5 moles of ethylene oxide; Neodol 23-9, an ethoxylated primary C₁₂-C₁₃ alcohol having about 9 moles of ethylene oxide; and Neodol 91-10, an ethoxylated C₉-C₁₁ primary alcohol having about 10 moles of ethylene oxide.

Alcohol ethoxylates of this type have also been marketed by Shell Chemical Company under the Dobanol trademark. Dobanol 91-5 is an ethoxylated C₉-C₁₁ fatty alcohol with an average of 5 moles ethylene oxide and Dobanol 25-7 is an ethoxylated C₁₂-C₁₅ fatty alcohol with an average of 7 moles of ethylene oxide per mole of fatty alcohol.

Other examples of suitable ethoxylated alcohol nonionic surfactants include Tergitol 15-S-7 and Tergitol 15-S-9, both of which are linear secondary alcohol ethoxylates available from Union Carbide Corporation. Tergitol 15-S-7 is a mixed ethoxylated product of a C₁₁-C₁₅ linear secondary alkanol with 7 moles of ethylene oxide and Tergitol 15-S-9 is the same but with 9 moles of ethylene oxide.

Other suitable alcohol ethoxylated nonionic surfactants are Neodol 45-11, which is a similar ethylene oxide condensation products of a fatty alcohol having 14-15 carbon atoms and the number of ethylene oxide groups per mole being about 11. Such products are also available from Shell Chemical Company.

Further nonionic surfactants are, for example, C₁₀-C₁₈ alkyl polyglycosides, such s C₁₂-C₁₆ alkyl polyglycosides, especially the polyglucosides. These are especially useful when high foaming compositions are desired. Further surfactants are polyhydroxy fatty acid amides, such as C₁₀-C₁₈ N-(3-methoxypropyl) glycamides and ethylene oxide-propylene oxide block polymers of the Pluronic type.

Examples of cationic surfactants are those of the quaternary ammonium type.

The total content of surfactants in the composition is desirably 60 to 95 wt %, especially 75 to 90 wt %. Desirably an anionic surfactant is present in an amount of 50 to 75 wt %, the nonionic surfactant is present in an amount of 5 to 50 wt %, and/or the cationic surfactant is present in an amount of from 0 to 20 wt %. The amounts are based on the total solids content of the composition, i.e. excluding any solvent which may be present.

The compositions, particularly when used as laundry washing or dishwashing compositions, may also independently comprise enzymes, such as protease, lipase, amylase, cellulase and peroxidase enzymes. Such enzymes are commercially available and sold, for example, under the registered trade marks Esperase, Alcalase and Savinase by Nova Industries A/S and Maxatase by International Biosynthetics, Inc. Desirably the enzymes are independently present in the primary or secondary compositions in an amount of from 0.5 to 3 wt %, especially 1 to 2 wt %, when added as commecial preparations they are not pure and this represents an equivalent amount of 0.005 to 0.5 wt % of pure enzyme.

The compositions may, if desired, independently comprise a thickening agent or gelling agent. Suitable thickeners are polyacrylate polymers such as those sold under the trade mark CARBOPOL, or the trade mark ACUSOL by Rohm and Haas Company. Other suitable thickeners are xanthan gums. The thickener, if present, is generally present in an amount of from 0.2 to 4 wt %, especially 0.5 to 2 wt %.

Compositions used in dishwashing an laundry independently usually comprise a detergency builder. The builders counteract the effects of calcium, or other ion, water hardness encountered. Examples of such materials are citrate, succinate, malonate, carboxymethyl succinate, carboxylate, polycarboxylate and polyacetyl carboxylate salts, for example with alkali metal or alkaline earth metal cations, or the corresponding free acids. Specific examples are sodium, potassium and lithium salts of oxydisuccinic acid, mellitic acid, benzene polycarboxylic acids, C₁₀-C₂₂ fatty acids and citric acid. Other examples are organic phosphonate type sequestering agents such as those sold by Monsanto under the trade mark Dequest and alkylhydroxy phosphonates. Citrate salts and C₁₂-C₁₈ fatty acid soaps are preferred. Further builders are; phosphates such as sodium, potassium or ammonium salts of mono-, di- or tri-poly or oligo-phosphates; zeolites; silicates, amorphous or structured, such as sodium, potassium or ammonium salts.

Other suitable builders are polymers and copolymers known to have builder properties. For example, such materials include appropriate polyacrylic acid, polymaleic acid, and polyacrylic/polymaleic and copolymers and their salts, such as those sold by BASF under the trade mark Sokalan.

The builder is desirably present in an amount of up to 90 wt %, preferably 15 to 90 wt %, more preferable 15 to 75 wt %, relative to the total weight of the composition. Further details of suitable components are given in, for example, EP-A-694,059, EP-A-518,720 and WO 99/06522.

The compositions can also independently optionally comprise one or more additional ingredients. These include conventional detergent composition components such as further surfactants, bleaches, bleach enhancing agents; builders, suds boosters or suds suppressors, anti-tarnish and anti-corrosion agents, organic solvents, co-solvents, phase stabilisers, emulsifying agents, preservatives, soil suspending agents, soil release agents, germicides, pH adjusting agents or buffers, non-builder alkalinity sources, chelating agents, clays such as smectite clays, enzyme stabilizers, anti-limescale agents, colourants, dyes, hydrotropes, dye transfer inhibiting agents, brighteners, and perfumes. If used, such optional ingredients will generally constitute preferably no more than 15 wt %, for example from 1 to 6 wt %, the total weight of the compositions.

Compositions which comprise an enzyme may optionally contain materials which maintain the stability of the enzyme. Such enzyme stabilizers include, for example, polyols such as propylene glycol, boric acid and borax. Combinations of these enzyme stabilizers may also be employed. If utilized, the enzyme stabilizers generally constitute from 0.1 to 5 wt %, ideally 0.1 to 1 wt % of the compositions.

The compositions may independently optionally comprise materials which serve as phase stabilizers and/or co-solvents. Example are C₁-C₃ alcohols such as methanol, ethanol and propanol. C₁-C₃ alkanolamines such as mono-, di- and triethanolamines can also be used, by themselves or in combination with the alcohols. The phase stabilizers and/or co-solvents can, for example, constitute 0 to 1 wt %, preferably 0.1 to 0.5 wt %, of the composition.

The compositions may independently optionally comprise components which adjust or maintain the pH of the compositions at optimum levels. The pH may be from, for example, 1 to 13, such as 8 to 11 depending on the nature of the composition. For example a dishwashing composition desirably has a pH of 8 to 11, a laundry composition desirable has a pH of 7 to 9, and a water-softening composition desirably has a pH of 7 to 9. Examples of pH adjusting agents are NaOH and citric acid.

The above examples may be used for dish or fabric washing. In particular dish washing formulations are preferred which are adapted to be used in automatic dish washing machines. Due to their specific requirements specialised formulation are required and these are illustrated below.

Amounts of the ingredients can vary within wide ranges, however preferred automatic dishwashing detergent compositions herein (which typically have a 1% aqueous solution pH of above 8, more preferably from 9.5 to 12, most preferably from 9.5 to 10.5) are those wherein there is present: from 5% to 90%, preferably from 5% to 75%, of builder; from 0.1% to 40%, preferably from 0.5% to 30%, of bleaching agent; from 0.1% to 15%, preferably from 0.2% to 10%, of the surfactant system; from 0.0001% to 1%, preferably from 0.001% to 0.05%, of a metal-containing bleach catalyst; and from 0.1% to 40%, preferably from 0.1% to 20% of a water-soluble silicate. Such fully-formulated embodiments typically further comprise from 0.1% to 15% of a polymeric dispersant, from 0.01% to 10% of a chelant, and from 0.00001% to 10% of a detersive enzyme, though further additional or adjunct ingredients may be present. Detergent compositions herein in granular form typically limit water content, for example to less than 7% free water, for better storage stability.

Non-ionic surfactants useful in ADW (Automatic Dish Washing) compositions of the present invention desirably include surfactant(s) at levels of from 2% to 60% of the composition. In general, bleach-stable surfactants are preferred. Non-ionic surfactants generally are well known, being described in more detail in Kirk Othmer's Encyclopedia of Chemical Technology, 3rd Ed., Vol. 22, pp. 360-379, “Surfactants and Detersive Systems”, incorporated by reference herein.

Preferably the ADW composition comprises at least one non-ionic surfactant. One class of non-ionics are ethoxylated non-ionic surfactants prepared by the reaction of a monohydroxy alkanol or alkylphenol with 6 to 20 carbon atoms with preferably at least 12 moles particularly preferred at least 16 moles, and still more preferred at least 20 moles of ethylene oxide per mole of alcohol or alkylphenol.

Particularly preferred non-ionic surfactants are the non-ionic from a linear chain fatty alcohol with 16-20 carbon atoms and at least 12 moles particularly preferred at least 16 and still more preferred at least 20 moles of ethylene oxide per mole of alcohol.

According to one preferred embodiment the non-ionic surfactant additionally comprise propylene oxide units in the molecule. Preferably this PO units constitute up to 25% by weight, preferably up to 20% by weight and still more preferably up to 15% by weight of the overall molecular weight of the non-ionic surfactant. Particularly preferred surfactants are ethoxylated mono-hydroxy alkanols or alkylphenols, which additionally comprises polyoxyethylene-polyoxypropylene block copolymer units. The alcohol or alkylphenol portion of such surfactants constitutes more than 30%, preferably more than 50%, more preferably more than 70% by weight of the overall molecular weight of the non-ionic surfactant.

Another class of non-ionic surfactants includes reverse block copolymers of polyoxyethylene and polyoxypropylene and block copolymers of polyoxyethylene and polyoxypropylene initiated with trimethylolpropane.

Another preferred non-ionic surfactant can be described by the formula:
R¹O[CH₂CH(CH₃)O]_{X}[CH₂CH₂O]_{Y}[CH₂CH(OH)R²]
wherein R¹ represents a linear or branched chain aliphatic hydrocarbon group with 4-18 carbon atoms or mixtures thereof, R² represents a linear or branched chain aliphatic hydrocarbon rest with 2-26 carbon atoms or mixtures thereof, x is a value between 0.5 and 1.5 and y is a value of at least 15.

Another group of preferred nonionic surfactants are the end-capped polyoxyalkylated non-ionics of formula:
R¹O[CH₂CH(R³)O]_{X}[CH₂]ₖCH(OH)[CH₂]ⱼOR²
wherein R¹ and R² represent linear or branched chain, saturated or unsaturated, aliphatic or aromatic hydrocarbon groups with 1-30 carbon atoms, R³ represents a hydrogen atom or a methyl, ethyl, n-propyl, iso-propyl, n-butyl, 2-butyl or 2-methyl-2-butyl group, x is a value between 1 and 30 and, k and j are values between 1 and 12, preferably between 1 and 5. When the value of x is ≧2 each R³ in the formula above can be different. R¹ and R² are preferably linear or branched chain, saturated or unsaturated, aliphatic or aromatic hydrocarbon groups with 6-22 carbon atoms, where group with 8 to 18 carbon atoms are particularly preferred. For the group R³H, methyl or ethyl are particularly preferred. Particularly preferred values for x are comprised between 1 and 20, preferably between 6 and 15.

As described above, in case x≧2, each R³ in the formula can be different. For instance, when x=3, the group R³ could be chosen to build ethylene oxide (R³=H) or propylene oxide (R³=methyl) units which can be used in every single order for instance (PO) (EO)(EO), (EO) (PO)(EO), (EO)(EO) (PO), (EO) (EO) (EO), (PO) (EO) (PO), (PO) (PO) (EO) and (PO) (PO) (PO). The value 3 for x is only an example and bigger values can be chosen whereby a higher number of variations of (EO) or (PO) units would arise.

Particularly preferred end-capped polyoxyalkylated alcohols of the above formula are those where k=1 and j=1 originating molecules of simplified formula:
R¹O[CH₂CH(R³)O]_{X}CH₂CH(OH)CH₂OR²

The use of mixtures of different non-ionic surfactants is particularly preferred in ADW formulations for example mixtures of alkoxylated alcohols and hydroxy group containing alkoxylated alcohols.

After the compartments have been filled, the compartments are closed by a lid. The lid may be of any form, so long as it is water-soluble.

The thickness of the film used for the lid may be less than the thickness of the film making up the compartment of the container because the film is not subjected to localised stretching in a thermoforming step, if thermoforming is used to form the compartments. It is also desirable to have a thickness which is less than that of the film used to form the first compartment to ensure a sufficient heat transfer through the film to soften the base web if heat sealing is used.

The thickness of the covering film is generally from 20 to 160 μm, preferably from 40 to 100 μm, such as 40 to 80 μm or 50 to 60 μm.

This film may be a single-layered film but is desirably laminated to reduce the possibility of pinholes allowing leakage through the film. The film may be the same or different as the film forming the first compartment. If two or more films are used to form the film comprising the second compartment, the films may be the same or different. Examples of suitable films are those given for the film forming the first compartment.

The lids are sealed to the compartments in order to enclose the compositions. Any method of sealing may be used. For example, the compartments and lids may simply be sealed by the application of pressure to the compartment or lid. It may be sealed to the compartment by any suitable means, for example by means of an adhesive or by heat sealing. Other methods of sealing include infra-red, radio frequency, ultrasonic, laser, solvent, vibration and spin welding. The seal desirably is water-soluble.

If heat sealing is used, a suitable sealing temperature is, for example, 185 to 205° C., for example 190 to 200° C. A suitable sealing pressure is, for example, from 250 to 600 kPa. Examples of sealing pressures are 276 to 552 kPa, especially 345 to 483 kPa or 400 to 800 kPa, especially 500 to 700 kPa depending on the heat sealing machine used. Suitable sealing dwell times are 0.4 to 2.5 seconds.

One skilled in the art can use an appropriate temperature, pressure and dwell time to achieve a seal of the desired integrity. While desirably conditions are chosen within the above ranges, it is possible to use one or more of these parameters outside the above ranges, although it would might be necessary to compensate by changing the values of the other two parameters.

The containers may be produced in pairs, each unit of the pair being joined by the folding portion. The containers may also be produced in strips of two, wherein the folding portion is the middle part of the strip between the lines of containers. The strips of containers may be used in the folding step as is, or individual pairs of containers, or shorter strips, may be prepared by cutting the strips at appropriate points.

Desirably, however, the containers are produced in a two-dimensional array. It is possible, for example, to have an array of up to 12 containers along one side and up to 10 containers along the second side. A suitable array size is four or six containers along one side, and four to eight containers along the other side. An especially preferred array size is eight containers along one side and six containers along the other side. If desired the array can be cut to provide a smaller array of containers, a strip of pairs of containers, or individual pairs. Preferably, however, the array is used as is in the folding step.

Once the containers have been produced, they may be separated from each other by cutting the areas between them. Alternatively, they may be left conjoined and, for example, perforations provided between the individual containers so that they can be easily separated a later stage, for example by a consumer. If the containers are separated, the flanges may be left in place. However, desirably the flanges are partially removed in order to provide an even more attractive appearance. Generally the flanges remaining should be as small as possible for aesthetic purposes while bearing in mind that some flange is required to ensure the two films remain adhered to each other. A flange having a width of 1 mm to 8 mm is desirable, preferably 2 mm to 7 mm, most preferably about 5 mm.

The folding portion, which by this time has been folded, may be retained in the containers. Desirably, however, it is at least partially removed, for example by trimming with a blade, to provide the containers with a more attractive appearance.

The containers of the present invention may have any desired shape.

The compartments may have the same or different size and/or shape. In general, if it is desired to have compartments containing different quantities of components, the compartments have volume ratios of from 2:1 to 20:1, especially from 4:1 to 10:1. The pairs of compartments may have the same lid size and shape for adhering to each other. Alternatively they may have a different size and/or a different shape. It is preferred that if the compartments have a different size, they have the same shape. In this case the lid of the smaller compartment is adhered to only part of the lid of the larger compartment. Two or more smaller compartments can, if desired, be adhered to the lid of the larger compartment.

The containers produced by the process of the present invention, especially when used for a fabric care, surface care or dishwashing composition, may have a maximum dimension of 5 cm, excluding any flanges. For example, a container may have a length of 1 to 5 cm, especially 3.5 to 4.5 cm, a width of 1.5 to 3.5 cm, especially 2 to 3 cm, and a height of 1 to 2 cm, especially 1.25 to 1.75 cm.

The containers may themselves be packaged in outer containers if desired, for example non-water soluble containers which are removed before the water-soluble containers are used.

THERMOFORMING HPMC

| | BOTTOM | | | | | | | |
|---|---|---|---|---|---|---|---|---|
| | FILM | | | HEAT | | DWELL | SEALING | SEALING |
| BOTTOM | (ON-LINE | TOP | CARRIER | TIME | TEMP | TIME | TEMP | TIME |
| FILM | LAMINATION) | FILM | FILM | (s) | (° C.) | (s) | (° C.) | (s) |
| HPMC | HPMC | HPMC | — | 4 | 130 | 1.5 | 195 | 1.5 |
| 75 | 75 | 75 | | | | | | |
| HPMC | — | HPMC | — | 4 | 130 | 1.5 | 195 | 1.5 |
| 120 | | 75 | | | | | | |
| HPMC | — | HPMC | PET | 4 | 130 | 3.5 | 188 | 1 |
| 120 | | 75 | 200 | | | | | |
| | | | micron | | | | | |
| HPMC | — | HPMC | PET | 4 | 130 | 3.5 | 195 | 1 |
| 120 | | 75 | 200 | | | | | |
| | | | micron | | | | | |
| HPMC | — | HPMC | PET | 4 | 130 | 1.5 | 195 | 1.5 |
| 75 | | 75 | 250 | | | | | |
| | | | micron | | | | | |
| HPMC | — | HPMC | | 4 | 130 | 1.5 | 195 | 1.5 |
| 75 | | 75 | | | | | | |
| HPMC | — | HPMC | | 4 | 130 | 1.5 | 195 | 1.5 |
| 100 | | 75 | | | | | | |

Solubility of HPMC Pouches

The solubility of HPMC pouches has been tested in laboratory and in real use conditions (washing machine).

Lab Test:

Method: 2 litres of Tap Water 20° C.; stirring system at 220 rpms; 8% by weight of a boron containing powder detergent is dissolved in the water. Time of liquid release and time of complete dissolution of the film are registered.

Results: Time of liquid release is in line with PVOH (40-50 sec) and is not influenced by the type of detergent used (with or without boron).

Complete dissolution time is about 6-7 (depending on the thickness of the film) minutes and still is not influenced by the presence of or absence boron in the detergent (PVOH capsules in presence of boron containing detergent are not completely dissolved after 20 minutes).

Washing Machine Solubility test: the washing machine tested can be divided into 2 groups.

1. Conventional Washing machine: water loaded≅18 lt.

2. Fuzzy Logic Machine: water loaded≅14 lt.

The tests were done combining the following variables:
Temperature of the cycle: 30° C.; 60° C.
Detergent: containing boron; non containing boron
Detergent dose: 121,5 gr. (normal suggested dose); 180 gr. (dose suggested for very dirty loaded); 243 gr. (extraordinary dirty loaded)
No. of caps used: 1 (suggested dose); 2; 3.

In the Fuzzy Logic Washing machine the situation is more critical than in the Conventional washing machine, as the water in which the film and the boron can dissolve is reduced. The risk of finding residues at the end of the washing cycle increases with the following parameters:
decreasing temperature (from 60 to 30° C.)
increasing detergent dose

increasing number of caps used

| | 121.5 g detergent | | | 180 g detergent | | | 243 g detergent | | |
|---|---|---|---|---|---|---|---|---|---|
| N° of | 1 | 2 | 3 | 1 | 2 | 3 | 1 | 2 | 3 |
| caps | cap | caps | caps | cap | caps | caps | cap | caps | caps |
| Con- | 100% | 100% | 100% | 100% | 100% | 100% | 100% | 100% | 100% |
| ven- | NR | NR | NR | NR | NR | NR | NR | NR | NR |
| tional | | | | | | | | | |
| Fuzzy | 100% | 100% | 100% | 100% | 100% | 100% | 100% | 100% | 100% |
| Logic | NR | NR | NR | NR | NR | NR | NR | NR | NR |

NR=no residue found
Compatibility with the Formulation

The formulation in the HPMC film is stable: both the chemical-physical parameters and the stability and activity of the active ingredients in the formulation.

Stability tests at different conditions have been conducted on the HPMC caps.

Storage conditions (at all conditions filled pouches were placed inside a PE (10/bag) inside a cartoon boxes—PE bags were stored closed and also open)
2° C. dry oven
RT
30° C./70% RH
40° C./75% RH
60° C. dry oven.
   Parameters Checked:
water up-date
capsule resistance
product leakage/diffusion.

The resistance to bursting under pressure is in line with the resistance of containers when first made.

1. A water-soluble container comprising at least one compartment prepared from a thermoformed film of hydroxy propyl methyl cellulose (HPMC).

2. A water-soluble container as claimed in claim 1 wherein the at least one compartment contains a fabric care, surface care or dishwashing composition.

3. A water-soluble container according to claim 1 wherein the at least one compartment is prepared from a laminated water-soluble film comprising at least one film of HPMC.

4. A water-soluble container according to claim 1 wherein the thickness of the HPMC film is 40 to 300 μm.

5. A process for preparing a water-soluble container comprising at least one compartment which process comprises:
a. feeding at least one HPMC film into a thermoforming machine;
b. heating the at least one HPMC film to a temperature of 120 to 140° C., for 1 to 10 seconds;
c. simultaneously or subsequently forming the at least one heated HPMC film into a mould;
d. filling the formed film pocket with at least one liquid or solid composition; and
e. sealing the formed and filled film pocket with a water-soluble film.

6. A process according to claim 5 wherein the at least one HPMC film is heated to a temperature of 125 to 135° C. for 2 to 6 seconds.

7. A process according to claim 5 wherein the mould is cooled.

8. A process according to claim 7 wherein the mould is cooled below room temperature.

9. A process claim 8 wherein the mould is cooled below 20° C.

10. A process according to claim 6 wherein the water-soluble used in sealing the formed and filled film pocket is a HPMC film.
